(19) United States
(12) Patent Application Publication
(10) Pub. No.: US 2019/0264765 A1
(43) Pub. Date: Aug. 29, 2019

(54) MAGNETIC BRAKE PAD WEAR SENSOR

(71) Applicant: TRW AUTOMOTIVE U.S. LLC, Livonia, MI (US)

(72) Inventor: DAVID LEONARD JUZSWIK, Commerce TWP, MI (US)

(21) Appl. No.: 16/319,906

(22) PCT Filed: Jul. 31, 2017
(86) PCT No.: PCT/US17/44600

§ 371 Date: Jan. 23, 2019

Related U.S. Application Data
(60) Provisional application No. 62/368,209, filed on Jul. 29, 2016.

(51) Int. Cl. F16D 66/02; B60T 17/22; F16D 55/226; G01B 5/00; G01B 7/06

(52) U.S. Cl. CPC F16D 66/027; B60T 17/221; F16D 66/023; F16D 66/024; F16D 2121/04; F16D 66/028; G01B 5/0028; G01B 7/10; F16D 55/226

(57) ABSTRACT

A brake pad wear measuring system is for use on a vehicle equipped with a tire pressure monitoring (TPM) system including a wheel mounted TPM sensor, and a floating caliper disc brake system including a piston supporting an inner brake pad and a floating caliper supporting an outer brake pad, wherein the piston and floating caliper move toward each other along a braking axis in response to application of the brake system so that the brake pads engage and apply a braking force to a brake rotor. The brake pad wear system includes a permanent magnet attached to the floating caliper. The permanent magnet generates a magnetic field and being positioned on the floating caliper so that the TPM sensor of the wheel passes through the magnetic field as the wheel rotates during vehicle operation. The system also includes a field sensor implemented in the TPM sensor. The field sensor detects the magnetic field as the TPM sensor passes through the magnetic field. The system further includes a ferromagnetic target mounted to the piston. The target has a portion positioned to move between the magnet and the TPM sensor in response to brake pad wear to attenuate the strength of the magnetic field acting on the TPM sensor.

### RELATED APPLICATION

This application claims the benefit of U.S. Provisional Application Ser. No. 62/368,209, filed on Jul. 29, 2016, the disclosure of which is incorporated herein by reference in its entirety.

### TECHNICAL FIELD

The invention relates generally to brake pad wear sensing systems and devices. More particularly, the invention relates to a magnetic brake pad wear sensor that utilizes a tire pressure monitoring system sensor to send wear information.

### BACKGROUND

It is desirable to sense and inform the driver when automotive brake pads need to be replaced. Known electronic brake wear sensors have a resistor circuit sensor that is cupped to the inner brake pad. As the pad is abraded away by the rotor, the sensor is also abraded away; changing its resistance. A pigtail harness is connected to the sensor which is wired to a sensing module in the vehicle.

There are several problems with the known approach. The multiple wire harnesses required and the additional sensing module makes this an expensive solution. Routing of the harnesses through the vehicle suspension and the wheel/steering knuckle area is very challenging and prone to road debris abuse. Additionally, the wear sensor has to be replaced each time the pads are replaced, which can be expensive.

While employing electronic sensors to detect brake pad wear, it is important to consider that the brake pad and brake caliper area can reach temperatures in excess of 300 degrees C., which many electronic sensors cannot withstand.

From a cost and implementation standpoint, it is desirable to not use any wire harness and to try to utilize existing product already on the vehicle to reduce the cost of transporting the pad wear information to the driver display. It is also desirable that it not be necessary to replace the brake pad wear sensor with the brake pads when they are replaced. It is also desirable that the brake pad wear sensor provides diagnostic (e.g., heartbeat) capabilities, and the sensor must be capable of withstanding the extreme temperatures seen during braking.

### SUMMARY

A brake pad wear measuring system is for use on a vehicle equipped with a tire pressure monitoring (TPM) system including a wheel mounted TPM sensor, and a floating caliper disc brake system including a piston supporting an inner brake pad and a floating caliper supporting an outer brake pad, wherein the piston and floating caliper move toward each other along a braking axis in response to application of the brake system so that the brake pads engage and apply a braking force to a brake rotor. The brake pad wear system includes a permanent magnet attached to the floating caliper. The permanent magnet generates a magnetic field and being positioned on the floating caliper so that the TPM sensor of the wheel passes through the magnetic field as the wheel rotates during vehicle operation. The system also includes a field sensor implemented in the TPM sensor. The field sensor detects the magnetic field as the TPM sensor passes through the magnetic field. The system further includes a ferromagnetic target mounted to the piston. The target has a portion positioned to move between the magnet and the TPM sensor in response to brake pad wear to attenuate the strength of the magnetic field acting on the TPM sensor.

According to one aspect, the target can move relative to the magnet in response to movement of the piston along the braking axis and in response to movement of the floating caliper along the braking axis.

According to another aspect, alone or in combination with any previous aspect, the target can move relative to the magnet a distance that is about equal to the total distance moved by both the inner and outer brake pads during application of the braking system.

According to another aspect, alone or in combination with any previous aspect, the distance the target moves in response to application of the braking system can increase with brake pad wear, which increases the degree to which the target attenuates the magnetic field acting on the field sensor.

According to another aspect, alone or in combination with any previous aspect, in response to the brake pads wearing to the point where replacement is required, the target can attenuate the magnetic field to a degree sufficient to prevent the field sensor from detecting passing through the magnetic field.

According to another aspect, alone or in combination with any previous aspect, the field sensor failing to detect passing through the magnetic field can be indicative of the brake pads needing replaced.

According to another aspect, alone or in combination with any previous aspect, the field sensor can produce a voltage in response to sensing the presence of the magnetic field, and the voltage can decrease in response to the target attenuating the magnetic field.

According to another aspect, alone or in combination with any previous aspect, the target can be mounted on the inner brake pad.

According to another aspect, alone or in combination with any previous aspect, the field sensor can include a coil that produces an induced voltage in response to passing through the magnetic field. The coil can include a TPM sensor coil utilized by the TPM system to sense the earth's gravitational field.

A brake pad wear measuring system can include a floating caliper disc brake system comprising a piston supporting an inner brake pad and a floating caliper supporting an outer brake pad, wherein the piston and floating caliper move toward each other along a braking axis during braking so that the brake pads engage and apply a braking force to a brake rotor. The system can also include a wheel mounted tire pressure monitoring (TPM) sensor comprising a field sensor for detecting a magnetic field A permanent magnet can be attached to the floating caliper. The permanent magnet generates a magnetic field and can be positioned on the floating caliper so that the TPM sensor passes through the magnetic field as the wheel rotates during vehicle operation. A ferromagnetic target can be mounted to the piston. The target can have a portion positioned to move between the magnet and the TPM sensor in response to brake pad wear to attenuate the strength of the magnetic field acting on the TPM sensor.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is a schematic illustration of an example vehicle configuration showing disc brake components mounted on vehicle suspension components.

FIG. 2 is a schematic illustration depicting a brake wear sensor system implemented on an example disc brake configuration, wherein the disc brake is shown in a non-braking condition.

FIG. 3 is a schematic illustration depicting the brake wear sensor system of FIG. 2, wherein the disc brake is shown in a first braking condition with brake pads at a first level of wear.

FIG. 4 is a schematic illustration depicting the brake wear sensor system of FIG. 2, wherein the disc brake is shown in a second braking condition with brake pads at a second level of wear.

### DETAILED DESCRIPTION

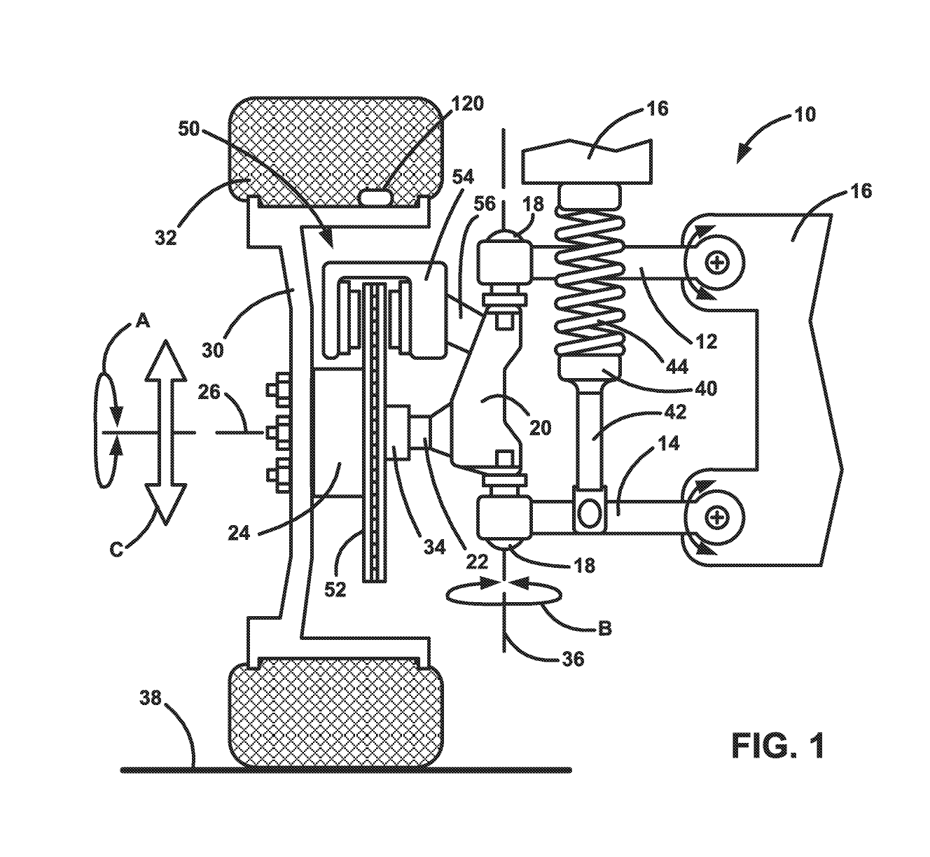

Referring to FIG. 1, an example vehicle suspension system 10 includes an upper control arm 12 and a lower control arm 14 that are connected to the vehicle 16 for pivoting movement. A steering knuckle 20 is connected to free ends of the control arms 12, 14 by ball joints or the like that permit relative movement between the knuckle and control arms. The steering knuckle 20 includes a spindle 22 that supports a wheel hub 24 for rotation (see arrow A) about a wheel axis 26. A wheel or rim 30 and tire 32 can be mounted on the wheel hub 24 by known means, such as lugs and lug nuts. The wheel hub 24 includes bearings 34 that facilitate rotation of the hub, rim 30, and tire 32 about the axis 26. The steering knuckle 20 is itself rotatable about a steering axis 36 (see arrow B) to steer the vehicle 16 in a known manner.

A damper 40, such as a shock absorber or strut, has a piston rod 42 connected to the lower control arm 14 and a cylinder 44 that is supported by structure of the vehicle 16, such as a vehicle frame-mounted bracket. The damper 40 dampens relative movement of the control arms 14, 16, and the steering knuckle 20 relative to the vehicle 16. The damper 40 can thus help dampen and absorb impacts between the road 38 and the tire 32, such as impacts with bumps, potholes, or road debris, that produce up and down movement (see arrow C) of the suspension system 10, the wheel 30, and the tire 32.

The vehicle 16 includes a disc braking system 50 that includes a brake disc 52 secured to the hub 24 for rotation with the hub, wheel 30, and tire 32. The disc braking system 50 also includes a brake caliper 54 that is secured to the steering knuckle 20 by a bracket 56. The disc 52 and the caliper 54 thus move in unison with the steering knuckle 20 through steering movements (arrow B) and suspension movements (arrow C). The disc 52 rotates (arrow A) relative to the caliper 54 and has an outer radial portion that passes through the caliper.

The configuration of the suspension system 10 shown in FIG. 1 is by way of example only and is not meant to limit the scope of the invention. The brake pad wear sensor system disclosed herein can be configured for utilization with any vehicle suspension configuration that implements disc brakes. For example, while the illustrated suspension system 10 is an independent front suspension, specifically an upper and lower control arm/A-arm (sometimes referred to as a double wishbone) suspension, other independent suspensions can be used. Examples of independent suspensions with which the brake pad wear sensing system can be implemented include, but are not limited to, swing axle suspensions, sliding pillar suspensions, MacPherson strut suspensions, Chapman strut suspensions, multi-link suspensions, semi-trailing arm suspensions, swinging arm suspensions, and leaf spring suspensions. Additionally, the brake pad wear sensing system can be implemented with dependent suspension systems including, but not limited to, Satchell link suspensions, Panhard rod suspensions, Watt's linkage suspensions, WOB link suspensions, Mumford linkage suspensions, and leaf spring suspensions. Furthermore, the brake pad wear sensing system can be implemented on front wheel disc brakes or rear wheel disc brakes.

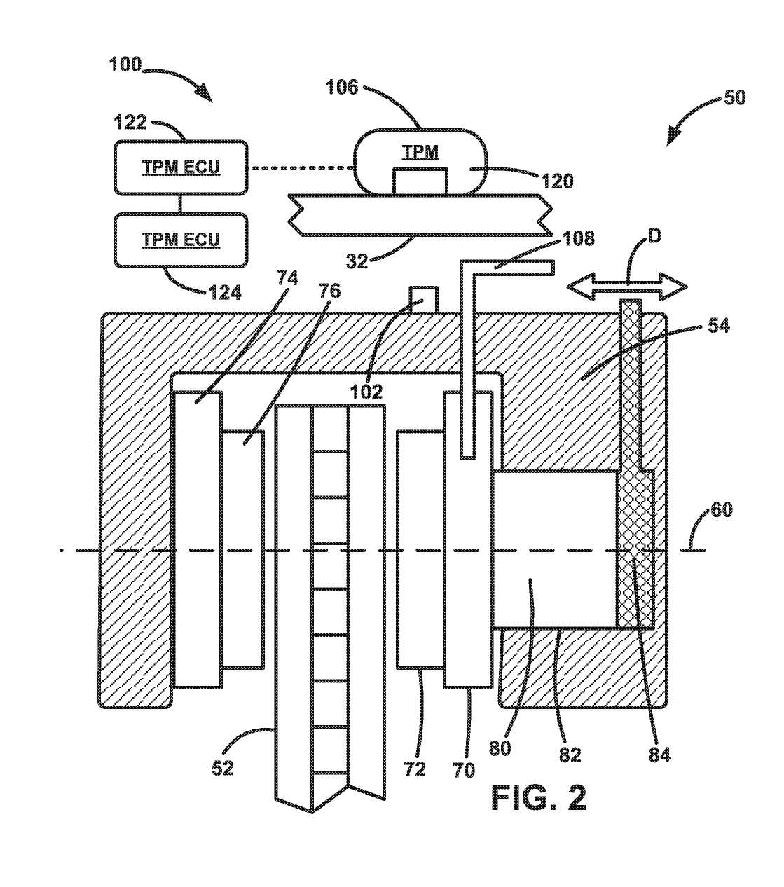

Referring to FIGS. 2-4, the disc braking system 50 is illustrated schematically and in greater detail. The brake system 50 is a single piston floating caliper system in which the connection of the caliper 54 to the vehicle 16 allows for axial movement of the caliper (“float”) relative to the brake disc 52. In this floating caliper configuration, the caliper 54 is permitted to move axially toward and away from the disc 52 (see arrow D) parallel to a braking axis 60.

The brake system 50 includes an inner brake shoe 70 that supports an inner brake pad 72, and an outer brake shoe 74 that supports an outer brake pad 76. The inner brake shoe 70 is supported on a piston 80. The outer brake shoe 74 is supported on the floating caliper 54. The piston 80 is disposed in a cylinder 82 that is supported on or formed in the floating caliper 54. Brake fluid 84 is pumped into the cylinder 82 in response to driver application of a brake pedal (not shown) in order to actuate the braking system 50.

The brake system 50 is maintained in the unactuated condition of FIG. 2 via bias applied by a biasing member (not shown), such as a spring. When the brake pedal is applied, the brake fluid 84 fills the cylinder 82 and applies fluid pressure to the piston 80, urging it to move to the left, as viewed in FIGS. 2-4. This causes the inner brake shoe 70 and pad 72 to move along the braking axis 60 toward and the brake disc 52. The inner brake pad 72 engaging the disc 52 creates a reaction force that acts on the floating caliper 54, due to its supporting of the piston 80 and cylinder 82. Since the piston 80 is blocked against movement toward the disc 52 due to the engagement of the inner brake pad 72 with the disc, the brake fluid pressure in the cylinder 82 urges the floating caliper 54 to move to the right, as viewed in FIGS. 2-4. The floating caliper 54, moving to the right, causes the outer brake shoe 74 and pad 76 to move along the braking axis 60 toward the brake disc 52. The inner pad 76 eventually engages the disc 52, which is now clamped between the inner and outer brake pads.

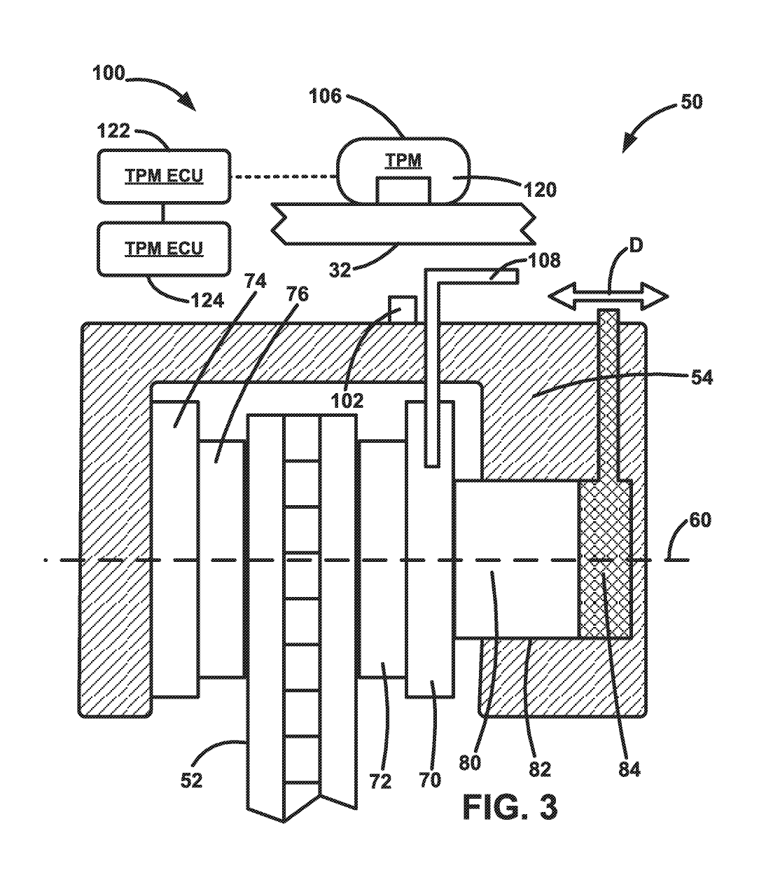

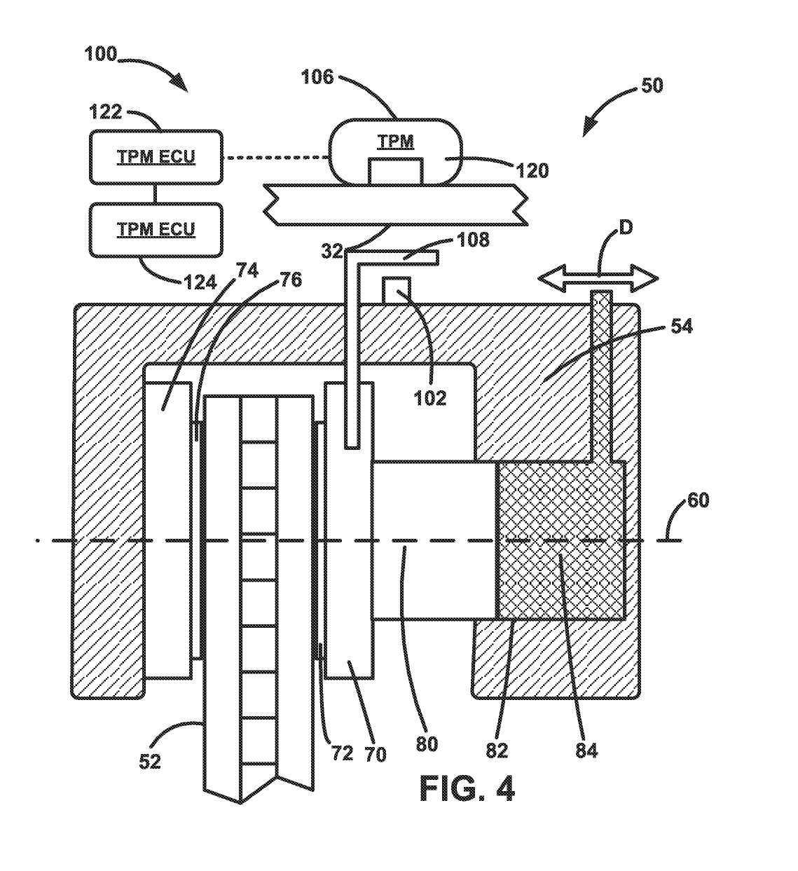

As the brake pads 72, 76 wear down, they become thinner. This is illustrated by comparing the brake pads 72, 76 of FIG. 3, which are fresh, thick, and unworn, to the brake pads of FIG. 4, which are old, thin, and worn-out. As seen in the comparison of FIGS. 3 and 4, owing to the floating caliper configuration of the brake system 50, both the piston 80 and the caliper 54 travel a greater distance when applying the worn pads of FIG. 4 than they do when applying the unworn pads.

The brake pad wear monitoring system 100 can be implemented via a tire pressure monitoring (TPM) system of the vehicle. The TPM system includes a wheel mounted TPM sensor 120 that communicates wirelessly with a TPM electronic control unit (ECU) 122. The TPM ECU 122 communicates with a central vehicle controller 124, such as a body control module (BCM). The TPM ECU 122 and/or the BCM 124 can receive and analyze the data received from the TPM sensor 120 in order to monitor and determine the status of the brake pads 72, 76. When worn brake pads are detected, the BCM 124 can cause the necessary warnings to be conveyed to the vehicle operator, e.g., via the instrument panel.

The brake pad wear system 100 also includes a permanent magnet 102 mounted on the brake caliper 54. The magnet 102, being a permanent magnet, has no issues with the extreme temperatures. The magnet 102 is positioned on the brake caliper 54 so that the magnetic field 110 it creates above the caliper is positioned in the path of the TPM sensor 120 for the associated wheel 30. Since the TPM sensor 120 is secured to the wheel 30, its axial position relative to the brake disc 52 is fixed. The TPM sensor 120 is outfitted with a field sensor 106, such as a sensor coil, that is configured to sense the presence of the magnet 102.

The brake pad wear monitoring system 100 also includes a target 108 secured for movement with the inner brake shoe 70, either to the shoe itself or to the pad 72 (e.g., on the brake pad backing material). The target 108 is constructed of a ferromagnetic material that will attract the magnetic flux of the field 110 produced by the magnet 102, thus attenuating the strength of the field acting on the field sensor 106. The system 100 is configured such that, as the wear on the brake pads 72, 76 increases and the distance the pads have to travel in order to apply braking forces increases, a greater portion of the target 108 moves between the magnet 102 and the field sensor 106, which increases the degree to which the target 108 attenuates the magnetic field acting on the field sensor 106. When the brake pads 72, 76 reach a predetermined amount of wear necessitating servicing and replacement of the pads, the target 108 will attract a portion of the magnetic flux in the field 110 that reduces the strength of the field acting on the field sensor 106 to a point where the field sensor senses a sufficiently low magnetic field or no magnetic field at all. It is this sufficiently low level magnetic field or lack thereof that indicates to the system that the pads 72, 76 are worn.

As the TPM sensor 120 mounted inside the wheel 32 rotates past the magnetic field 110, the field sensor 106 reacts to its presence through a voltage induced in the sensor coil. The TPM sensor 120 sensing entering and exiting the magnetic field during driving forms a diagnostic heartbeat indicating that the brake pads are OK and the wear sensor system 100 is operational. When the brake pads are worn, the target 108 covers the magnet 102 and attenuates the magnetic field 110, causing cessation of the heartbeat, which indicates that the brakes need service, i.e., either the pad(s) 72, 76 are worn or the sensor system 100 is not operational.

Additionally, the amplitude of the signal produced in the field sensor 106 can indicate the amount of wear on the pads. To this end, the system 100 can periodically send the peak amplitude of the received signal to the TPM ECU 122. The TPM ECU 122 can calibrate the amplitude of the signal to a vehicle/rim/wheel configuration, by knowing when the pads have been changed and whether they are new. Differences in the wheel/rim type or construction of the tire could cause variations in the amplitude of the signal, but these can be calibrated out through processing. If only simple brake pads good/bad detection is required, this calibration may not be necessary.

Additionally and advantageously, since the magnet 102 is secured to the floating caliper 54 and the target 108 is secured to the inner brake pad 72, the brake wear system 100 is sensitive to wear on both the inner and outer pads 72, 76. In the floating caliper system 50, the inner/piston side pad 72 is moved first relative to the caliper 54 into engagement with the disk 52. Then, the outer/opposite pad 76 moves with the caliper 54 relative to the piston 80 and the inner pad, which are essentially fixed in position due to their engaging the rotor disk. Therefore, by placing the magnet 102 on the floating caliper 54 and placing the target 108 on the piston mounted inner pad 72, the target 108 moves relative to the magnet 102 in response to both the initial movement of the inner pad 72 and the subsequent movement of the outer pad 76. The total distance that the target 108 moves in response to application of the braking system is equal to or about equal to the combined distance that the inner and outer pads 72, 76 move to engage the disc 52. The field sensor 106 therefore can measure the cumulative wear of both the inner and outer brake pads 72, 76 and can account for uneven/unequal wear between the pads in the pair.

TPM sensors are known to sense the earth's magnetic field in order to determine a tire location associated with the sensor. Examples of these include U.S. Pat. No. 9,031,738 B2 and U.S. Pat. No. 9,259,979 B2, which are incorporated herein by reference. The magnetic field of the earth is significantly less than the magnetic strength of the magnetic field that would be associated with a permanent magnet passing in such close proximity to the TPM sensor. Therefore, if the TPM sensor 120 has this known magnetic field sensing capability, the field sensor already included in the TPM sensor design can be utilized as the field sensor 106 for the brake pad wear system 100. Modification of the TPM sensor 120 can thus be avoided, and the brake pad wear sensing system 100 can be included simply by adding the magnet 102 and the target 108, an re-programming the TPM ECU 122 to detect the spike in the sensed magnetic field caused by the presence of the magnet.

From the above, those skilled in the art will appreciate that the brake pad wear system 100 can offer several advantageous features. From a cost standpoint, the sensor doesn't require replacement every time the brake pads are serviced. All that is required is that the replacement pads include the target 108. On this point, the target 108 could be an integral component of the brake shoe 70, 74 or pad 76, 78; or the target could be a separate component that is connectable to the shoe/bad, for example, via the shoe or pad mounting hardware.

Additionally, the brake pad wear system 100 avoids the needing to include wiring harnesses and complicated wire routing. Since the system 100 utilizes existing vehicle features, i.e., the TPM sensor system, the system is improved from a cost standpoint. Furthermore, the system 100 is sensitive to brake pad wear on both brake pads 72, 76, not just the inner pad. This sensitivity is enhanced by the potential for determining not just that wear has occurred but, through measuring sensor voltage amplitude, the amount of wear as well.

From the above description of the invention, those skilled in the art will perceive improvements, changes and modifications. Such improvements, changes and modifications within the skill of the art are intended to be covered by the appended claims.

We claim:

1. A brake pad wear measuring system for use on a vehicle equipped with a tire pressure monitoring (TPM) system including a wheel mounted TPM sensor, and a floating caliper disc brake system comprising a piston supporting an inner brake pad and a floating caliper supporting an outer brake pad, wherein the piston and floating caliper move toward each other along a braking axis in response to application of the brake system so that the brake pads engage and apply a braking force to a brake rotor, the brake pad wear system comprising:
a permanent magnet attached to the floating caliper, the permanent magnet generating a magnetic field and being positioned on the floating caliper so that the TPM sensor of the wheel passes through the magnetic field as the wheel rotates during vehicle operation;
a field sensor implemented in the TPM sensor, the field sensor detecting the magnetic field as the TPM sensor passes through the magnetic field; and
a ferromagnetic target mounted to the piston, the target having a portion positioned to move between the magnet and the TPM sensor in response to brake pad wear to attenuate the strength of the magnetic field acting on the TPM sensor.

2. The brake pad wear measuring system recited in claim 1, wherein the target moves relative to the magnet in response to movement of the piston along the braking axis and in response to movement of the floating caliper along the braking axis.

3. The brake pad wear measuring system recited in claim 1, wherein the target moves relative to the magnet a distance that is about equal to the total distance moved by both the inner and outer brake pads during application of the braking system.

4. The brake pad wear system recited in claim 1, wherein the distance the target moves in response to application of the braking system increases with brake pad wear, which increases the degree to which the target attenuates the magnetic field acting on the field sensor.

5. The brake pad wear system recited in claim 4, wherein, in response to the brake pads wearing to the point where replacement is required, the target attenuates the magnetic field to a degree sufficient to prevent the field sensor from detecting passing through the magnetic field.

6. The brake pad wear system recited in claim 1, wherein the field sensor failing to detect passing through the magnetic field is indicative of the brake pads needing replaced.

7. The brake pad wear system recited in claim 1, wherein the field sensor produces a voltage in response to sensing the presence of the magnetic field, and the voltage decreases in response to the target attenuating the magnetic field.

8. The brake pad wear system recited in claim 1, wherein the target is mounted on the inner brake pad.

9. The brake pad wear system recited in claim 1, wherein the field sensor comprises a coil that produces an induced voltage in response to passing through the magnetic field.

10. The brake pad wear system recited in claim 9, wherein the coil comprises a TPM sensor coil utilized by the TPM system to sense the earth's gravitational field.

11. A brake pad wear measuring system comprising:
a floating caliper disc brake system comprising a piston supporting an inner brake pad and a floating caliper supporting an outer brake pad, wherein the piston and floating caliper move toward each other along a braking axis during braking so that the brake pads engage and apply a braking force to a brake rotor;
a wheel mounted tire pressure monitoring (TPM) sensor comprising a field sensor for detecting a magnetic field;
a permanent magnet attached to the floating caliper, the permanent magnet generating a magnetic field and being positioned on the floating caliper so that the TPM sensor passes through the magnetic field as the wheel rotates during vehicle operation; and
a ferromagnetic target mounted to the piston, the target having a portion positioned to move between the magnet and the TPM sensor in response to brake pad wear to attenuate the strength of the magnetic field acting on the TPM sensor.
